(19) United States
(12) Patent Application Publication
(10) Pub. No.: US 2013/0346151 A1
(43) Pub. Date: Dec. 26, 2013

(54) SYSTEMS AND METHODS FOR AUTOMATED VALUATION OF REAL ESTATE DEVELOPMENTS

(71) Applicants: Tara J. Bleakley, Aliso Viejo, CA (US); Jon A. Wierks, Tustin, CA (US)

(72) Inventors: Tara J. Bleakley, Aliso Viejo, CA (US); Jon A. Wierks, Tustin, CA (US)

(73) Assignee: Corelogic Solutions, LLC, Santa Ana, CA (US)

(21) Appl. No.: 13/530,431

(22) Filed: Jun. 22, 2012

(51) Int. Cl. G06Q 50/16; G06Q 10/02

(52) U.S. Cl. 705/7.31; 705/7.29

(57) ABSTRACT

Examples of systems and methods for determining automated valuations of real estate developments are disclosed. In various embodiments, the systems and methods can receive information on properties that are to be constructed in the development. The systems and methods can use automated valuation models (AVMs) to calculate valuations for the properties and to determine a valuation for the development based at least partly on the AVM valuations. In some implementations, the systems and methods can forecast market demand for the properties and generate a sales timeline for projected sales of the properties. The systems and methods can be used to value residential, commercial, or mixed-use real estate developments.

### BACKGROUND

1. Field

The present disclosure relates to systems and methods for determining a valuation of a real estate development.

2. Description of Related Art

To develop a real estate property, a real estate developer can, for example, purchase the property, determine a land use and development plan, hire contractors, engineers, architects, or builders to build structures on the property according to the plan, market the completed development to end purchasers, and coordinate and finance the development project. As the scale and scope of real estate developments has increased, the task of estimating development costs and expected profits has become increasingly complicated.

### SUMMARY

Examples of systems and methods for determining automated valuations of real estate developments are disclosed. In various embodiments, the systems and methods can receive information on properties that are to be constructed in the development (referred to as “virtual properties”). The systems and methods can use automated valuation models (AVMs) to calculate valuations for the virtual properties and to determine a valuation for the development based at least partly on the AVM valuations. In some implementations, the systems and methods can forecast market demand for the properties and generate a sales timeline for projected sales of the properties. The systems and methods can be used to value residential, commercial, or mixed-use real estate developments.

In one aspect, a method for determining a valuation for a real estate development is disclosed. The method comprises receiving information for a plurality of virtual properties associated with a real estate development in a geographic area, each virtual property representing a property that has been constructed or is planned to be constructed in the real estate development. The method also comprises automatically valuing each of the virtual properties using one or more automated valuation models (AVMs), and determining, by execution of instructions by a physical computing system, a valuation for the real estate development based at least partly on the automated valuations of each of the virtual properties.

In another aspect, a system for determining a valuation for a real estate development is disclosed. The system comprises non-transitory computer storage configured to store (1) information for a plurality of virtual properties associated with a real estate development in a geographic area, each virtual property representing a property that has been constructed or is planned to be constructed in the real estate development, and (2) at least one valuation for each of the plurality of virtual properties. The system also comprises a physical computing system in communication with the non-transitory computer storage. The physical computing system can be programmed to determine a valuation for the real estate development based at least partly on the valuations of each of the virtual properties.

In another aspect, non-transitory computer storage having stored thereon computer-executable instructions for determining a valuation for a real estate development is disclosed. The computer executable instructions comprise instructions for accessing (1) information for a plurality of virtual properties associated with a real estate development in a geographic area, each virtual property representing a property that has been constructed or is planned to be constructed in the real estate development, and (2) at least one valuation for each of the plurality of virtual properties, and determining a valuation for the real estate development based at least partly on the valuations of each of the virtual properties.

The real estate development in any of the disclosed aspects may include a residential real estate development.

Details of one or more implementations of the subject matter described in this application are set forth in the accompanying drawings and the description below. Other features, aspects, and advantages will become apparent from the description, the drawings, and the claims.

### BRIEF DESCRIPTION OF THE DRAWINGS

FIG. 1 is a block diagram that schematically illustrates an example of a system to determine a valuation for a real estate development.

FIG. 2 shows an example of a report summarizing valuations for a real estate development.

FIG. 3 shows an example of a market demand and sales timeline report for a real estate development.

FIG. 4 is a flowchart that shows an example of a method for determining a valuation for a real estate development.

FIG. 5 is a flowchart that shows an alternative example of a method for determining a valuation for a real estate development.

FIG. 6 is a flowchart that shows an example of a method for determining market demand forecasts and sales timelines for a real estate development.

Throughout the drawings, reference numbers may be re-used to indicate correspondence between referenced elements. The drawings are provided to illustrate example embodiments described herein and are not intended to limit the scope of the disclosure.

### DETAILED DESCRIPTION

### Overview

Valuing a real estate development project can be challenging and may involve numerous poorly known data inputs or speculative assumptions. Accordingly, the present disclosure provides examples of systems and methods that can be used to provide automated valuations for real estate developments. For example, the systems and methods can estimate a total value for a real estate development based on estimated values for the particular types of properties planned to be constructed in the development (“virtual properties”). The total value of the development can include an estimated valuation of the completed development including amenities in the development. Upper and/or lower limits on the valuation can be provided. Further, in some embodiments, a timeline for the expected sale prices of individual properties may be provided.

Accordingly, real estate developers, homebuilders, master-planned community developers, land bankers, lenders, financiers, municipalities, or speculative investors looking to plan, value, or sell real estate developments can use the disclosed systems and methods to determine estimated valuations for the development. User of the systems and methods can evaluate different land use scenarios, construction and marketing timelines, etc. for the development. Users can determine estimated valuations for a variety of different projected development plans in order, for example, to determine the plan that provides the highest valuation for the development, the plan that provides the shortest sales time line, the plan that provides the least development costs, and so forth. The estimated valuations can also be used to determine whether to purchase the land to be used for the development, whether to finance a development (and if so, by how much), and to determine profit exit strategies for the developer.

Example implementations of the systems and methods will be described in the context of a residential real estate development in which single-family dwellings (e.g., homes, condominiums, town homes) are to be built on an underlying property. However, the following examples are provided to illustrate and not to limit the systems and methods. In other implementations, the systems and methods can determine valuations for commercial or mixed-use (e.g., residential and commercial) real estate developments.

### Example Real Estate Development Valuation Systems

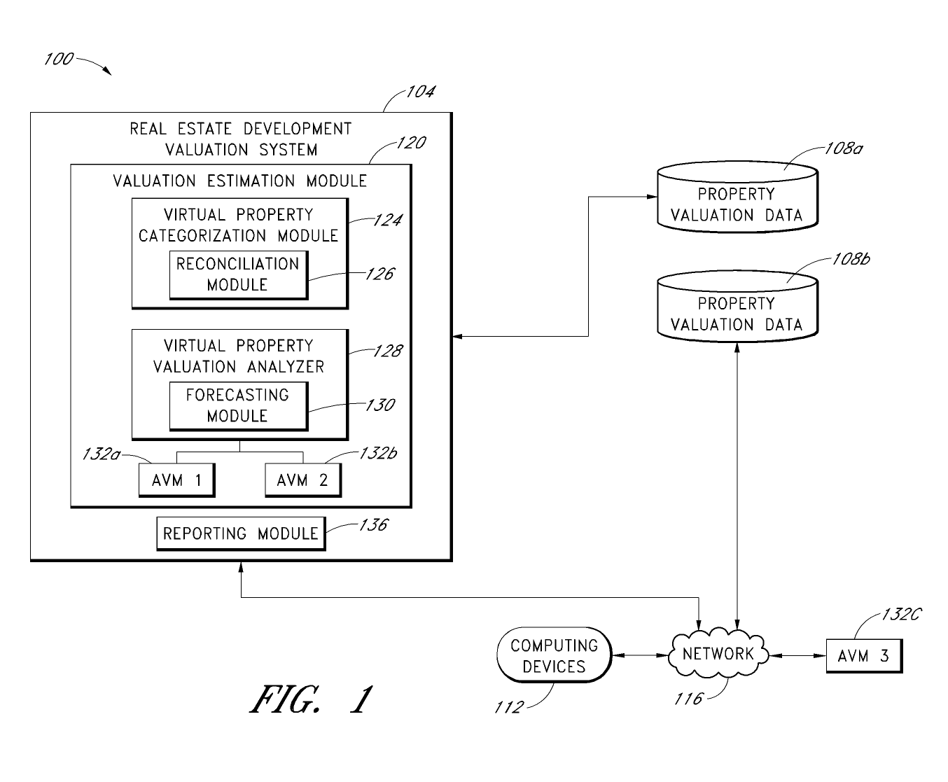

FIG. 1 is a block diagram that schematically illustrates an example of a system 100 to determine a valuation for a real estate development. The example system 100 includes a real estate development valuation system 104 that can be hosted or implemented on one or more physical computing systems such as computer servers. The valuation system 100 can be in communication with one or more data stores 108a, 108b that store property valuation data (described further below) used to determine the valuation of the real estate development. The data stores 108a, 108b can be implemented on any type of computer storage medium. Some of the data stores can be local to the valuation system 104 (e.g., the data store 108a) and other data stores may be remotely connected to the system 104 through a network 116 (e.g., the data store 108b). For example, the valuation system 104 may access property valuation data from third-party data providers via the network 116. Although the example system 100 in FIG. 1 shows two data stores 108a, 108b, any number of data stores (e.g., 1, 3, 4, 5, or more) can be used.

One or more computing devices 112 can communicate with the valuation system 100 over the network 116. A user of the system 100 can use one of the computing devices 112 to request or access valuation information from the system 100. The computing devices 112 can include general purpose computers, data input devices (e.g., terminals or displays), web interfaces, portable or mobile computers, laptops or tablets, smart phones, etc. The network 116 can provide wired or wireless communication between the computing devices 112 and the valuation system 104. In some implementations, the data stores 108a, 108b can communicate with the valuation system 104 (and/or the computing devices 112) over the network 116. The network 116 can be a local area network (LAN), a wide area network (WAN), the Internet, an intranet, combinations of the same, or the like. In certain embodiments, the network 116 can be configured to support secure shell (SSH) tunneling or other secure protocol connections for the secure transfer of data between the valuation system 104, the computing devices 112, and/or the data stores 108a, 108b.

In the embodiment illustrated in FIG. 1, the valuation system 104 includes a valuation estimation module 120 that includes a virtual property categorization module 124 and a virtual property valuation analyzer 128. The system 104 can also include a reporting module 136 that performs reporting, auditing, and other communication functions with managers and users of the system 100.

1. Examples of Virtual Property Categorization

The categorization module 124 can be used to receive information about and categorize the types of properties that are to be constructed according to a development plan for the real estate development. These properties will be referred to as “virtual properties,” because the “virtual” characteristics (e.g., type of property, square footage, number bedrooms, etc.) of each of the virtual properties can be used by the valuation analyzer 128 to determine a valuation for the development. For example, the valuation of the development can be a sum of the individual valuations for each of the virtual properties. Virtual properties can include properties that have yet to be built in the development and can be specified by each property's proposed characteristics as set forth in the development plan. In some implementations, virtual properties can also include properties that have actually been built in the development. For example, their actual characteristics can be input into the system 100, and such properties can be valued as if they were virtual. Thus, the system 100 can value individual properties based on the individual property's characteristics input to the system 100, whether or not the individual property has already been built or is to be built in the future. In some embodiments, the system 100 can receive “real world” valuations of properties that have actually been built (e.g., an appraisal valuation, a sales price, or other valuation), and the system 100 can use, at least partly, such real world valuations when valuing properties.

The virtual property categorization module 124 can receive or access virtual property characteristics of the individual properties described in the development plan for the development and/or through geospatial information (e.g., longitude and latitude) from geographic information systems (GIS). For example, the categorization module 124 can receive or access the virtual property characteristics from the from the data stores 108a, 108b or from users via the computing devices 112. In the context of a residential development, the virtual property characteristics for a particular property can include geographic information (e.g., address or zip code), property-specific information (e.g., type of property, description of the property), development-specific information (e.g., presence or absence of local amenities, scenic views, schools, parks, gates), etc.

In one example implementation, the virtual property characteristics for virtual properties in a development include geographic information such as zip code or address. The geographic information for a property can be useful in determining neighborhood boundaries and which properties may have an influence on the valuation. The property location can also be determined by geospatial coordinates (e.g., geocodes) or the latitude and longitude of the property. The virtual property characteristics can also include a physical description of the property. For example, the physical description can include lot size (e.g., entered as width and length or dwelling per acre), gross living area (GLA), bedroom count, bathroom count, number of floors, stories, or levels, garage description (e.g., garage space, whether one-car or multiple-car), whether the property has a heater or air conditioner, whether the property has any property-specific amenities such as its own pool or spa, and so forth. The virtual property characteristics of the development can include the total number of properties in the development, the minimum property size, property type (e.g., single family dwelling, condominium, town home), minimum number of bedroom(s), minimum number of bath(s), minimum garage space(s), whether the property has a basement (and whether finished or unfinished), and the number of floors or levels for the properties.

The virtual property characteristics can also include information on features of the development that can influence value. Examples of such features that tend to positively influence value are scenic views, golf courses, swimming pools, parks, schools, day care centers, presence of gates (manned or unmanned), etc. Examples of features that tend to negatively influence value are close proximity to highways, railroads, telephone lines or electrical power lines, poor performing schools, close proximity to high crime areas, etc. In some implementations, such data can be acquired via geospatial geographic information systems (GIS), via user input, or other data sources. Multiple listing service (MLS) listing information can be accessed to provide information on how long properties in the surrounding area have been for sale and changes to the asking price. MLS data may also include months of supply and market inventory. In some implementations, the system 100 can access MLS data (e.g., over the network 116) from services that use the Real Estate Transaction Standard (RETS), which provides a common standard for MLS data exchange between computing systems. The system 100 additionally or alternatively can access machine-readable versions of MLS information (or other information). For example, the machine-readable version can include an extensible markup language (XML) version of fields in MLS listings. Other information that can be used includes sales transaction history by price for properties in the surrounding area can be used, the share (or percentage) of properties with positive equity or negative equity, etc.

The categorization module 124 can optionally include a reconciliation module 126 that can analyze the virtual property characteristics to check for errors or inconsistencies. By identifying (and/or correcting) such errors or inconsistencies, the system 100 can provide more accurate valuations. The reconciliation module 126 may analyze conformity of the virtual property characteristics relative to characteristics of properties in the surrounding area or neighborhood or to sales comparables, and MLS listing information to identify possible errors or inconsistencies in the characterization of the virtual property. The reconciliation module 126 may also check some or all data fields in the virtual property characteristics data for reasonableness of the data entered in the field. Examples of questionable or unreasonable data inputs include a lot that has been input as having 3000 square feet with a home having a size of 15000 square feet, or a home having a size of 1250 square feet with 10 bathrooms. Example of other types of errors the reconciliation module 126 may identify and report include whether a property zip code is in a standardized format provided by the United States Postal Service, whether the properties are located outside of a geographic location for which the system can access property valuation data, and whether the properties are in a geographic location that is difficult to value. For example, certain rural areas or extremely high-end custom areas can be difficult to value. Properties with poor sales comparable data or serious characteristic data deficiencies can also be included in this category.

In some implementations, the reconciliation module 126 may communicate an error notification (e.g., an electronic mail, text message, or other type of report or log) to a user or system administrator if an error is found. For example, the notification may indicate that the user/administrator should check the fields identified as unreasonable by the reconciliation module 126 and re-enter the data, if necessary. In some such cases, the valuation system 104 may halt further processing until the questionable fields have been re-entered and subsequently reconciled by the reconciliation module 126 as being reasonable. In other cases, the valuation system 104 may continue processing after automatically modifying questionable fields to have default parameters (e.g., rather than 10 bathrooms, a single bathroom could be assumed). After receiving a valuation for the development, a user or administrator could check an error log (or an error section of a valuation report) to determine which fields may be questionable, and if the default parameters were unreasonable, the user or administrator could update the fields and re-run the valuation.

2. Examples of Virtual Property Valuation Analysis

After information about the virtual properties has been received or accessed by the system 100 (and optionally reconciled), the valuation analyzer 128 can determine a value for each virtual property by receiving or accessing a valuation provided by one or more automated valuation models (“AVMs”) 132a, 132b, and 132c. Generally, an AVM is a computerized system that can provide a valuation for a property (e.g., an estimate of a fair market value for the property) based on a mathematical model that takes into account, for example, characteristics, prices (e.g., comparable sales or “comps”), and price trends of the property and the surrounding area or neighborhood. In the system 100, the AVMs 132a-132c, the categorization module 124, and/or the valuation analyzer 128 can access the property valuation data from the data stores 108a, 108b.

One or more of the AVMs may be integrated with or local to the valuation system 104 (e.g., AVM1 132a and AVM2 132b) and/or remotely accessed over the network 116 (e.g., AVM 132c). The valuation system 104 can use proprietary AVMs and/or third party AVMs (e.g., AVM3 132c could be an operated by a third-party unaffiliated with the system 100). Although a single AVM can be used, in some implementations multiple AVMs are used to provide better estimates (or ranges of estimates) for the virtual properties. For example, multiple AVM valuations can be received for a property, and the valuation used by the valuation analyzer 128 can be an average of the multiple AVM valuations. In some cases, a weighted average can be used, with the weight of an individual AVM valuation based at least partly on an accuracy estimate for the AVM valuation (e.g., a forecast standard deviation for the AVM). Examples of AVMs usable with various embodiments of the system 100 include, but are not limited to, the ValuePoint4 AVM, the Home Price Analyzer (HPA) AVM, the PowerBASE6 AVM, and the PASS AVM, all available from Corelogic (Santa Ana, Calif.), and the Home Value Explorer (HVE) AVM available from Freddie Mac (McLean, Va.).

a. Examples of Property Valuation Data

An AVM may access property valuation data from the data stores 108a, 108b and use the data to determine a valuation for a virtual property. In various embodiments, the property valuation data can include property specific characteristics such as the type of property (e.g., single family residence, condominium, town home, commercial property, etc.), characteristics of the property (e.g., the number of bedrooms and bathrooms for a single family residence or the number of leasable units in a commercial property, whether improvements have been made to the property, etc.), geographic information (e.g., the address or zip code of the property), the quality of the property (e.g., as determined by a physical inspection), information on prior or current sale prices, appraisals or valuations, information on prior or current loans secured by the property, the nature of the loans (e.g., whether for purchase or for refinance), and so forth. The property valuation data can include information about the neighborhood or area in the vicinity of the property (e.g., other properties in the same zip code), typical dwelling type, share of commercial, multifamily, industrial, zoning classification, and proximity to externalities or amenities in the area (e.g. golf courses, swimming pools, schools, parks, landfills, highways, bodies of water). Property valuation data can also include the volume of recent property transactions, homogeneity of the housing stock, property valuation trends (e.g., whether the local market is appreciating or depreciating), rates of delinquency, foreclosures, refinances, or short sales, etc. Property valuation data can be obtained from a multiple listing service (MLS). For example, MLS listing information can indicate how long properties in the surrounding area have been for sale and changes to the asking price for the properties. MLS listing information may also include months of supply and market inventory.

In some implementations, for each virtual property, the valuation analyzer 128 (or an individual AVM) can determine the location of the virtual property by using geographic data (e.g., zip code) and access property valuation data for that geographic area. If no property valuation data exists for the geographic location of the virtual property, the valuation analyzer 128 may not be able to generate a virtual property valuation and may return an error notification to the user or administrator. The valuation analyzer 128 (or an individual AVM) can access the property valuation data in data stores 108a or 108b to search for and identify properties in the geographic location that are similar to the virtual properties (e.g., have the same use code type) and which have recent sales transactions. The nature of the geographic area can influence search parameters used in the searches for relevant properties. For example, the search parameters can include distance from the property and how far back in time to search for relevant transactions. In some embodiments, an initial search is performed with relatively small distance or time parameters, and if too few relevant transactions are found, the extent of the search parameters can be increased and the search broadened until sufficient “comps” are found for an AVM valuation to be performed.

As discussed further below, some implementations of the system 100 can forecast market demand for properties in the development to provide a projected sales timeline and valuations for the development. Accordingly, the property valuation data can also include scores or metrics reflecting property values, sales demand, or sales propensity. For example, in certain embodiments, the property valuation data can include the HomeStandings Score, which grades the relative strengths and weaknesses of the localized market, the Home Price Index (HPI) and/or HPI Forecast, which forecast home price trends, market volatility and elasticity, and information from the Negative Equity Report, which estimates equity and negative equity shares and trends for single-family residential properties. The foregoing scores and forecasts are available from Corelogic (Santa Ana, Calif.). The property valuation data can also include information on distressed transactions, real estate owned (REO) transactions, foreclosures, and loan delinquency. Other data sources providing information on market demand, historical price trends, and future market trends can be accessed and analyzed for use in the valuations or sales forecasts for the development.

b. Examples of Property Development Valuations

The valuations of the virtual properties determined by the AVM(s) can be combined to provide a valuation for the development. For example, the virtual property valuations can be summed to determine the valuation for a development V_{development} with N virtual properties

$${V}_{development} = {\sum }_{i = 1}^{N} V ( virtual {property}_{i} ) , \qquad ( 1 )$$

where V(virtual propertyᵢ) is the AVM valuation of the ith virtual property. The valuation for the development given in Equation (1) represents an estimate of the value of the development if all the properties were constructed and sold at the present time. However, properties take time to be constructed, as well as being constructed in phases in some planned communities. As will be discussed further below, in other embodiments, the system 100 also can forecast market demand for the properties, determine an approximate sales timeline for projected property sales, and provide valuations based on the sales timeline. In some such embodiments, projected future cash flows from property sales can be discounted to the present time (e.g., using a discount factor or interest rate) to provide a net present value of the development. In some implementations, the system 100 can receive information on estimated costs for the development, and determine a residual land value for the underlying land by subtracting the development costs from the valuation provided by Equation (1). Development costs can include hard costs (e.g., costs for constructing the properties) and soft costs (e.g., broker, marketing, or financing fees, etc.).

The system 100 can determine valuations of the entire development (e.g., if N represents the total number of properties in the development plan) or portions (or subsets) of the development (e.g., if N is less than the total number of properties to be constructed). Thus, the system 100 can determine valuations for sub-divisions, plans, or phases within a master development. In some implementations, the AVM virtual property valuations may return an upper or lower bound on the virtual property valuations, and the system 100 accordingly can determine upper or lower bounds on the valuation for the development. Further, some AVMs return an accuracy estimate for an AVM valuation (e.g., a forecast standard deviation), and in some embodiments the accuracy estimates can be combined to determine an accuracy estimate for the valuation of the development (e.g., a forecast standard deviation for V_{development}).

The reporting module 136 can output an electronic report summarizing the valuation for the real estate development. For example, the reporting module 136 can communicate the report to a user over the network 116 via electronic mail or store the report in non-transitory data storage. The reporting module 136 can communicate the report (or valuations within the report) via text message. The system 100 can provide a graphical user interface (GUI) by which a user can access the system 100 (e.g., via a web browser or an application (e.g., app or widget) on a computing device 112) in order to input data or user requirements for the valuation and to receive or access the valuation report. In some implementations, the system 100 provides an application programming interface (API) by which software applications can be programmed to access the system 100 to input or retrieve data, property valuations, reports, etc.

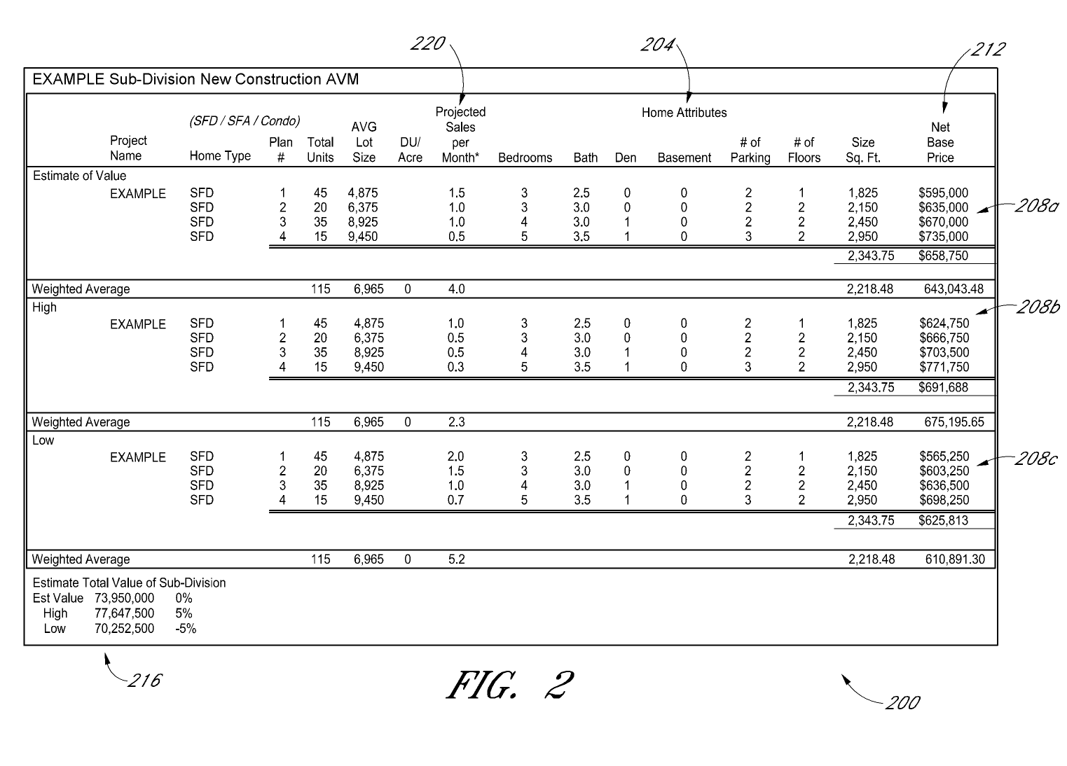

FIG. 2 shows an example of a report 200 that can be provided by the reporting module 136 of the system 100. This example report is for a residential real estate sub-division development which is projected to have a total of 115 single family dwellings (SFD) sold in four plans with 45, 20, 35, and 15 units, respectively. The report 200 summarizes the attributes 204 of the virtual properties (homes in this case): number of bedrooms and baths, whether there is a den (expressed as a Boolean true/false (1/0) value), the number of parking spaces in the garage, the number of floors in the home, and the size of the home in square feet. The report 200 also lists the average lot size in square feet (in other example, the lot size could be provided as dwelling units (DU) per acre).

The example report 200 includes three different valuation sections 208a, 208b, and 208c that summarize the estimated virtual property valuations for a base case 208a and also valuations with prices increased by 5% (208b, labeled “High”) and decreased by 5% (208c, labeled “Low”). The AVM valuations for the virtual properties in each of the plans for the development are listed in column 212 (labeled “Net Base Price”) of the report 200. Column 212 also lists the arithmetic average AVM valuation of the homes for the four plans as well as a weighted average valuation (where the weighting is proportional to the number of units in each plan). The report 200 also shows the base, high, and low estimated total values 216 of the sub-division. In this example, the base estimated valuation for the sub-division is $73,950,000.

The example report 200 also includes a column 220 listing projected sales per month for the homes in each of the plans. The projections are optional and can be performed by an optional forecasting module 130 described below. The report 200 is provided as an illustrative example and is not intended to be limiting. In other reports, some or all of the data shown in the report 200, as well as additional or different data, can be provided by the reporting module 136.

3. Examples of Market Demand Forecasts and Sales Timelines for the Development

Certain implementations of the system 100 can forecast market demand for the virtual properties, determine a sales timeline for projected property sales in the development, and provide projected property valuations based on the sales timeline. The projected valuation for the development (or individual properties within the development) over time can be calculated based on the sales timeline. Certain such implementations use the forecasting module 130 to perform the forecasts and projections. For example, the forecasting module 130 can calculate average market demand using price points for the virtual properties and determine the sales timeline based at least partly on the forecast market demand and price points. The forecasting module 100 can accommodate situations in which the properties are developed in phases, for example, a first group of properties constructed and sold in phase 1, a second group of properties constructed and sold in phase 2 (which may, but need not be, at a later date than phase 1), and so forth.

The forecasting module 130 can analyze a number of factors that can affect property selling propensity including the supply, inventory, and demand for properties and volatility of the property market in the area of the development, conformity of the development properties as compared to the surrounding area, and so forth. The forecasting module 130 can access such information from the property valuation data stores 108a, 108b. Thus, in certain implementations, the system 100 can perform a market analysis based on such factors to determine the current characteristics of the real estate market in the area of the development. For example, the forecasting module 130 can analyze price differences between similar comparable properties as one possible indicator of market conditions. If similar properties are selling for very different prices, a volatile market may be indicated. Large percentages of distressed and REO sales may also be an indicator of a volatile market. The forecasting module 130 can also analyze the number of recent sales in relation to the density of the area. If the current market is very slow, the property sales in the development may take a long to complete. The forecasting module 130 can use one or more forecasting models or algorithms to perform the forecasts such as, e.g., mean reversion methods, Holt-Winters methods, weighted or non-weighted moving averages, exponential smoothing, autoregressive moving average models, etc. The forecasting module 130 can account for seasonal factors and/or trends in the data.

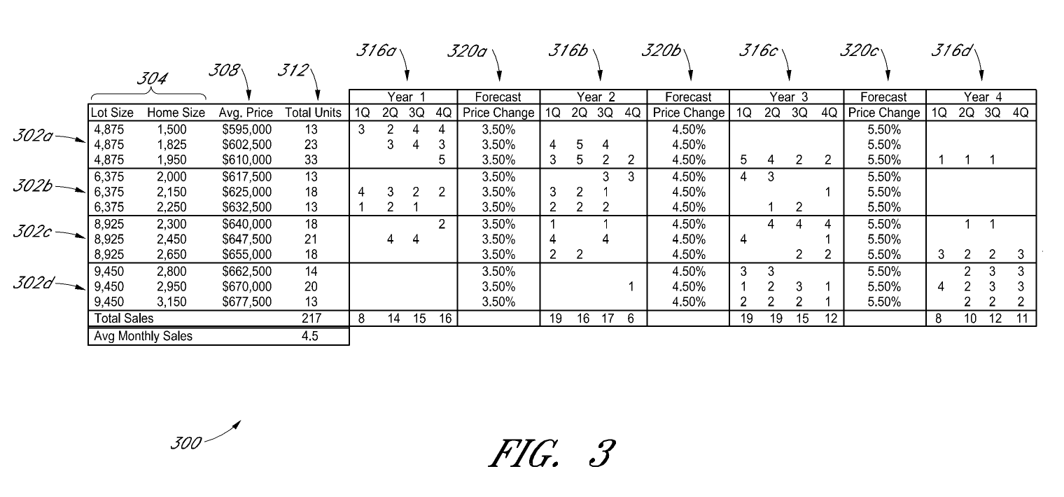

FIG. 3 shows an example of a market demand and sales timeline report 300 for a real estate development. The report 300 can be provided by the reporting module 136. In this example, the real estate development includes 217 residential properties that are sold in four plans or phases 302a-302d. The lot size and home size (in square feet) for each type of home are shown in column 304 and the number of such homes is shown in column 312. As discussed, the system 100 can use AVM valuations to estimate an average price for each type of property (column 308). The forecasting module 130 can estimate price changes for the properties over time (columns 320a, 320b, and 320c) to determine price points for future sales. Based at least partly on the project market demand and price points for each type of property, the forecasting module 130 can calculate a sales timeline showing the number of sales of each type of property over time. The sales timelines for years 1, 2, 3, and 4 are presented in columns 316a, 316b, 316c, and 316d, respectively, in which numbers of sales of each type of home per quarter are shown. The report 300 also shows the average monthly sales for the development. The report 300 is provided as an illustrative example and is not intended to be limiting. In other reports, some or all of the data shown in the report 300, as well as additional or different data, can be provided by the reporting module 136.

### Example Real Estate Development Valuation Methods

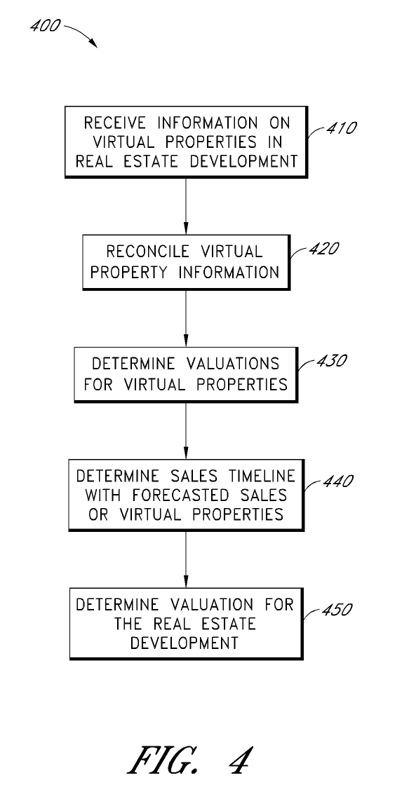

FIG. 4 is a flowchart that shows an example of a method 400 for determining a valuation for a real estate development. At block 410, the method 400 receives information on the virtual properties in the real estate development. For example, the method 400 may access a development plan that includes information on plans or phases within the development and the types and characteristics of the properties planned to be constructed in the development (or that may have already been constructed). At block 420, the virtual property information can be reconciled to determine if errors, inconsistencies, or unreasonable data is included in the information. As discussed with reference to the reconciliation module 126, the method 400 may halt if inconsistent data is found, or in other embodiments, the method may continue after attempting to reconcile the data (e.g., via using default values for questionable data entries).

At block 430, the method 400 can determine valuations of the virtual properties, for example, by using one or more AVMs to value the virtual properties based at least in part on the information received at block 410. The AVMs may additionally access property valuation information to perform the valuations. At block 440, the method 400 can determine a sales timeline that projects the number of sales of the virtual properties over time. At block 450, the method 400 can provide a valuation for the development. For example, the valuation can represent an estimate of the value of the development if all the properties were sold at the current time (e.g., see Eq. (1)) or a valuation based on the projected sales timeline. For example, projected future cash flows from property sales can be discounted to the present time (e.g., using a discount factor or interest rate) to provide a net present value of the development.

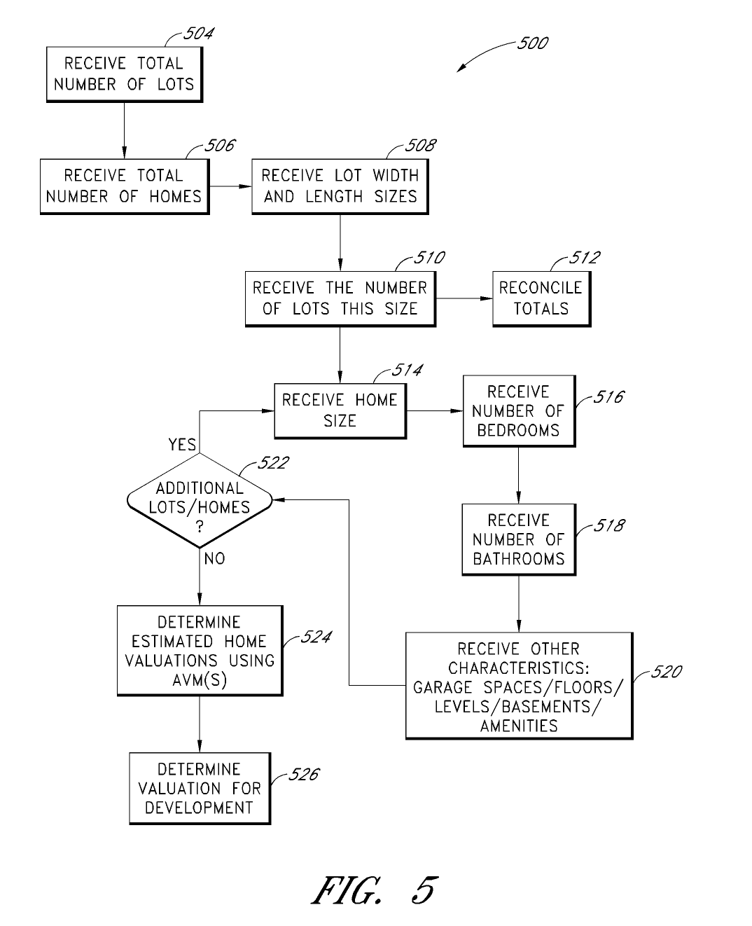

FIG. 5 is a flowchart that shows an alternative example of a method 500 for determining a valuation for a real estate development. The example method 500 can be implemented by various embodiments of the real estate development valuation system 104 and can access property valuation data from the data stores 108a, 108b.

In this example, the development is a residential sub-division in which homes are to be constructed on residential lots in the development. At blocks 504 and 506, the method 500 receives the total number of lots and the total number of homes in the sub-division. At block 508, the method 500 receives the size of the lots, e.g., width and length of the lot. At block 510, the method 500 receives the number of lots having the size specified at block 508. At block 512, the method 500 can reconcile the numerical values received at blocks 504-508 to determine if there are discrepancies or inconsistencies. As discussed above, if discrepancies or inconsistencies are identified, the method 500 may halt and communicate an error message to a user, or the method 500 may proceed by attempting to reconcile the data (e.g., using reasonable default values). In some implementations of the method 500, the reconciliation block 512 may be performed after other blocks in which virtual property data is received (e.g., after blocks 516-520).

At block 514, the method 500 can receive the home size (e.g., in square feet). At blocks 516-520, the method 500 can receive other virtual characteristics for the virtual homes, for example, number of bedrooms (block 516), number of bathrooms (block 518), and garage space, number of floors or levels, presence or size of basements, and amenities (e.g., a spa or pool) (block 520). At block 522, the method 500 determines whether information for additional lots or homes is to be received. In response to determining that there are additional lots or homes, the method 500 returns to block 514. In response to determining that the relevant information for the sub-division has been received, the method 500 continues at block 524, where one or more AVM valuations of the virtual properties are performed. At block 526, the method 500 determines a valuation for the development (e.g., via Eq. (1)). In other implementations, the method 500 may forecast projected sales of the homes, for example, as described with reference to block 440 of the method 400 or method 600 described below.

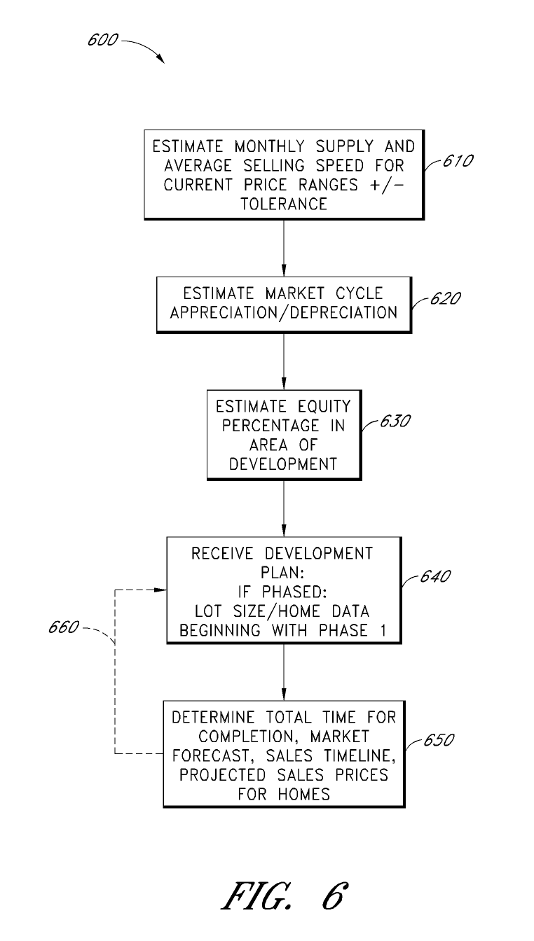

FIG. 6 is a flowchart that shows an example of a method 600 for determining market demand forecasts and sales timelines for a real estate development. In this example, the real estate development is a residential development. In some cases, it has been found that the following factors can be used to determine the selling propensity for properties in a development: home sales transactions and listings, market volatility and market cycle trends, and equity percentage in the area near the development. The method 600 can utilize such information to forecast market demand for the properties and determine an estimated sales timeline (and valuations) for the properties.

In this example, at block 610, the method 600 estimates monthly supply and average selling speed for homes in the geographic area of the development. The geographic area may be determined as having the same zip code as the development (or neighboring zip codes). MLS listing information on home supply, inventory, or demand, and sales closing data can be used. The method 600 may receive tolerances (e.g., +/−15%) in order to provide estimated upper or lower bounds on the supply and selling speed for homes. At block 620, the method 600 estimates market cycle trends in the area. For example, the method 600 can estimate appreciation or depreciation in values for the homes in the area. In some cases, the method 600 can use market indices such as HPI to forecast home price trends, market volatility, and elasticity in the area. At block 630, the method 600 can estimate equity percentage (or negative equity percentage) in the area.

At block 640, the method 600 receives a development plan that includes information on the virtual properties in the real estate development. Some embodiments of the method 600 can accommodate phased developments in which groups of properties may be constructed at different times (e.g., phase 1 in year 1, phase 2 in year 2, and so forth) or in different locations within the development (e.g., phase 1 at a north end, phase 2 at a south end, and so forth). As discussed herein, at block 640, the method 600 can reconcile the virtual property data to account for errors, inconsistencies, or questionable or unreasonable data.

The information received and estimates performed at blocks 610-640 can be used at block 650 to determine the market demand and sales timeline for the properties. For example, the method 600 can determine the total time for completion of the real estate development (e.g., the time to sell all the properties) and a breakout of forecasted sales of the properties (e.g., sales per month or quarter; see example sales timeline in FIG. 3). The sales timeline can include estimated sales prices for the properties (e.g., as determined by AVM(s)) as well as upper or lower bounds on the estimated sales prices. The market demand and sales timeline can be used by a real estate developer to determine whether to purchase the underlying land to make the development and to determine profitable exit strategies. The market demand and sales timeline can be used by a lender to determine whether to finance the developer, and if so, by how much.

In some instances, a developer may wish to determine which of a number of potential development plans meets the developer's goals, for example, to provide the highest valuation for the development or the shortest time to sell the properties. Accordingly, in some implementations of the method 600, blocks 640 and 650 can be repeated (as shown by arrow 660) for different development plans. The method 600 (or the developer) can analyze the results for each development plan to determine which plan most closely meets (or exceeds) the developer's goal for the development.

The example methods 400, 500, and 600 can be implemented by various embodiments of the real estate development valuation system 100 shown in FIG. 1. For example, the valuation estimation module 120 can be programmed to implement embodiments of the methods 400, 500, and 600. Systems implementing the methods 400, 500, 600 can access property valuation data from the data stores 108a, 108b. The example methods 400, 500, and 600 are intended to be illustrative and not limiting. In the foregoing examples, not all blocks are required, and additional or different blocks can be included in other implementations of the methods. Further, the blocks can be reordered, rearranged, combined, or performed differently than shown.

### CONCLUSION

Although the foregoing illustrative examples were described in the context of systems and methods for valuing residential developments, this is not a limitation, and the systems and methods described herein can also be implemented for other types of real estate developments. For example, implementations of the disclosed systems and methods can be used for valuing commercial property developments such as office complexes, industrial or warehouse complexes, retail and shopping centers, and apartment rental complexes. In other implementations, valuations can be provided for mixed use developments (e.g., a development including a condominium tower, single family lots, office buildings, and a retail mall).

The various illustrative logic, logical blocks, modules, and algorithm operations described in connection with the implementations disclosed herein may be implemented as electronic hardware, computer software, or combinations of both. The interchangeability of hardware and software has been described generally, in terms of functionality, and illustrated in the various illustrative components, blocks, modules, and algorithms described above. Whether such functionality is implemented in hardware or software depends upon the particular application and design constraints imposed on the overall system.

The hardware and data processing apparatus used to implement the various illustrative logic, logical blocks, modules, and algorithms described in connection with the aspects disclosed herein may be implemented or performed with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular operations and methods may be performed by circuitry that is specific to a given function. The hardware and data processing apparatus can be located in a single geographical location (e.g., as part of a local network) or located in multiple distinct geographical locations (e.g., connected via one or more private or public networks).

In one or more aspects, the methods, processes, algorithms, and functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

If implemented in software, the functions may be stored on or transmitted over as one or more instructions or code on a computer-readable medium. The operations of a method or algorithm disclosed herein may be implemented in a processor-executable software module which may reside on a computer-readable medium. Computer-readable media include both nontransitory computer storage media and communication media including any medium that can be enabled to transfer a computer program from one place to another. Storage media may be any available media that may be accessed by a computer. By way of example, and not limitation, such computer-readable media may include RAM, ROM, EEPROM, CD-ROM or other optical disk storage, flash memory, magnetic disk storage or other magnetic storage devices, or any other medium that may be used to store desired program code in the form of instructions or data structures and that may be accessed by a computer. Combinations of the above also may be included within the scope of computer-readable media. Additionally, the operations of a method or algorithm may reside as one or any combination or set of codes and instructions on a machine-readable medium and computer-readable medium, which may be incorporated into a computer program product.

The systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure. Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted can be incorporated in the example methods and processes that are schematically illustrated. For example, one or more additional operations can be performed before, after, simultaneously, or between any of the illustrated operations. Additionally, the operations may be rearranged or reordered in other implementations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for determining a valuation for a real estate development, the method comprising:
receiving information for a plurality of virtual properties associated with a real estate development in a geographic area, each virtual property representing a property that has been constructed or is planned to be constructed in the real estate development;
automatically valuing each of the virtual properties using one or more automated valuation models (AVMs); and
determining, by execution of instructions by a physical computing system, a valuation for the real estate development based at least partly on the automated valuations of each of the virtual properties.

2. The method of claim 1, wherein receiving information for the plurality of virtual properties comprises receiving at least one of: (1) geographic information associated with the location of the virtual property or the geographic area of the real estate development, (2) property-specific information for the virtual property, and (3) development information associated with the real estate development.

3. The method of claim 2, wherein the geographic information comprises at least one of a zip code, an address, longitude and latitude, and geospatial coordinates.

4. The method of claim 2, wherein the property-specific information comprises at least one of a type of the virtual property and characteristics of the virtual property.

5. The method of claim 4, wherein the type of the virtual property includes one or more of single family dwelling, condominium, and town home, or the characteristics of the virtual property include one or more of: lot size, dwelling size, gross living area, bedroom count, bathroom count, number of floors, stories, or levels, garage data, basement data, heating or cooling data, and presence of property-specific amenities.

6. The method of claim 2, wherein the development information comprises one or more of information associated with the presence or absence of schools, parks, scenic views, swimming pools, or golf courses in or near the real estate development.

7. The method of claim 1, wherein the information for the plurality of virtual properties comprises information on phases in which the properties are to be developed.

8. The method of claim 1, further comprising reconciling the information for the plurality of virtual properties to identify potentially inconsistent or unreasonable data.

9. The method of claim 8, further comprising communicating an error notification if inconsistent or unreasonable data is identified.

10. The method of claim 1, wherein determining the valuation of the real estate development comprises combining the automated valuations of each of the virtual properties.

11. The method of claim 1, further comprising forecasting future sales of the properties in the development.

12. The method of claim 11, wherein forecasting future sales comprises determining one or more of supply, inventory, or demand for properties in the geographic area of the real estate development, market cycle trends, volatility, or elasticity for properties in the geographic area of the real estate development, and equity or negative equity for properties in the geographic area of the real estate development.

13. The method of claim 11, wherein forecasting future sales comprises determining a sales timeline comprising information on projected sales of the properties over time.

14. The method of claim 13, wherein the sales timeline comprises information on projected sales prices for the properties.

15. The method of claim 14, wherein determining the valuation for the real estate development comprises determining a net present value for the real estate development based on discounting cash flows from the projected sales prices of the properties.

16. The method of claim 1, wherein the method is repeated for each of a plurality of development plans for the real estate development.

17. The method of claim 16, further comprising:
receiving a goal for the real estate development; and
automatically identifying at least one of the plurality of development plans that most closely meets or exceeds the goal.

18. The method of claim 17, wherein the goal comprises a target valuation for the real estate development or a target date for selling the properties in the real estate development.

19. The method of claim 1, further comprising determining an estimate of accuracy for the valuation for the real estate development.

20. The method of claim 19, wherein the estimate of accuracy is determined based at least partly on forecast standard deviations associated with the automated valuations by the AVMs.

21. The method of claim 1, wherein the real estate development comprises a residential real estate development.

22. A system for determining a valuation for a real estate development, the system comprising:
non-transitory computer storage configured to store (1) information for a plurality of virtual properties associated with a real estate development in a geographic area, each virtual property representing a property that has been constructed or is planned to be constructed in the real estate development, and (2) at least one valuation for each of the plurality of virtual properties; and
a physical computing system in communication with the non-transitory computer storage, the physical computing system programmed to:
determine a valuation for the real estate development based at least partly on the valuations of each of the virtual properties.

23. The system of claim 22, wherein at least some of the valuations for the plurality of virtual properties are generated by an automated valuation model (AVM).

24. The system of claim 23, wherein the physical computing system is further programmed to generate at least some of the valuations of the plurality of virtual properties using an AVM.

25. The system of claim 22, wherein the physical computing system is programmed to determine the valuation of the real estate development by combining the valuations of each of the plurality of virtual properties.

26. The system of claim 22, wherein the physical computing system is programmed to reconcile the information for the plurality of virtual properties to identify potentially inconsistent or unreasonable data.

27. The system of claim 26, wherein the physical computing system is programmed to communicate an error notification if inconsistent or unreasonable data is identified.

28. The system of claim 22, wherein the physical computing system is programmed to forecast future sales of the properties in the development.

29. The system of claim 28, wherein to forecast future sales, the physical computing system is programmed to determine one or more of supply, inventory, or demand for properties in the geographic area of the real estate development, market cycle trends, volatility, or elasticity for properties in the geographic area of the real estate development, and equity or negative equity for properties in the geographic area of the real estate development.

30. The system of claim 28, wherein the physical computing system is programmed to determine a sales timeline comprising information on projected sales of the properties over time.

31. The system of claim 30, wherein the sales timeline comprises information on projected sales prices for the properties.

32. The system of claim 31, wherein to determine the valuation for the real estate development, the physical computing system is programmed to determine a net present value for the real estate development based on discounted cash flows from the projected sales prices of the properties.

33. Non-transitory computer storage having stored thereon computer-executable instructions for determining a valuation for a real estate development, the computer executable instructions comprising instructions for:
accessing (1) information for a plurality of virtual properties associated with a real estate development in a geographic area, each virtual property representing a property that has been constructed or is planned to be constructed in the real estate development, and (2) at least one valuation for each of the plurality of virtual properties; and
determining a valuation for the real estate development based at least partly on the valuations of each of the virtual properties.

34. The non-transitory computer storage of claim 33, further comprising instructions for reconciling the information for the plurality of virtual properties to identify potentially inconsistent or unreasonable data.

35. The non-transitory computer storage of claim 33, further comprising instructions for forecasting future sales of the properties in the development.
